(19) United States
(12) Patent Application Publication
(10) Pub. No.: US 2009/0158901 A1
(43) Pub. Date: Jun. 25, 2009

(54) Assembly driver

(76) Inventor: Takashi Itoh, Tokyo (JP)

Correspondence Address: JORDAN AND HAMBURG LLP, 122 EAST 42ND STREET, SUITE 4000, NEW YORK, NY, 10168, US

(21) Appl. No.: 11/628,528

(22) PCT Filed: Aug. 31, 2006
(86) PCT No.: PCT/JP06/17192

§ 371 Date: Nov. 30, 2006

(30) Foreign Application Priority Data
Aug. 30, 2006 (JP) 2006-233981

(51) Int. Cl. B25B 23/00; B25F 1/02; B25B 15/00

(52) U.S. Cl. 81/439; 7/167; 7/165

(57) ABSTRACT

The invention include a guide groove of a long hole shape make the part excluding the root part of any one driver bit which was formed in top plate of the cap attached several pieces of the cap engaging rotatably and removably project to the method of outside and lead the driver bit to the support crevice. The base material of the outline shape of the supporter of the driver bit mostly and it was really formed so that it might project to the inner side in the inside wall of the circumference wall by the side of the central part of the guide groove of the top plate of the cap. The locking peace formed in the inner wall of the open end of the cap so that it can stop the rotation part which can prevent that plurality driver bits enter to the guide groove of this cap. And the invention has a few parts, and can set it the state where the driver bit chosen by easy operation can be used, and the storage state easily. It is purpose that offering the assembly driver can prevent the driver bit projecting, easily and carelessly.

### BACKGROUND OF THE INVENTION

Conventionally, the selection pipe rotatably attached to the tip part of the grip handle which chooses the used six driver bit stored in the grip handle in this kind of the assembly driver. It leads the selected driver bit rotatably attached this selection pipe to the support crevice of the tip part of the handle, and the rotation of the supported driver bit is impossible, and it comprises the cap in which the base material of the long hole which prevents unnecessary projection of a driver bit, and the shape of a C character was formed. For this reason, since the selection pipe and the cap are provided in the tip part of the grip handle, the structure is complicated, there was the fault that the cost became high, the operation was complicated, the set of the required driver bit, and the storage of the driver bit in use were complicated, and there was the fault that it was troublesome.

### SUMMARY OF INVENTION

In view of the above conventional faults, this invention has a few parts, and can set it the state where the driver bit chosen by easy operation can be used, and the storage state easily. It is purpose that offering the assembly driver can prevent the driver bit projecting, easily and carelessly. This invention sets it as other purposes to offer the assembly driver which can be prevented movement of the driver bit in use, and the slide movement of other driver bits by easy operation. Said this invention, the other purposes, and the new feature will become clear more completely, if the next explanation is referred to an accompanying drawing.

However, the drawing is for description chiefly and does not limit the technical scope of this invention.

### BRIEF DESCRIPTION OF ART

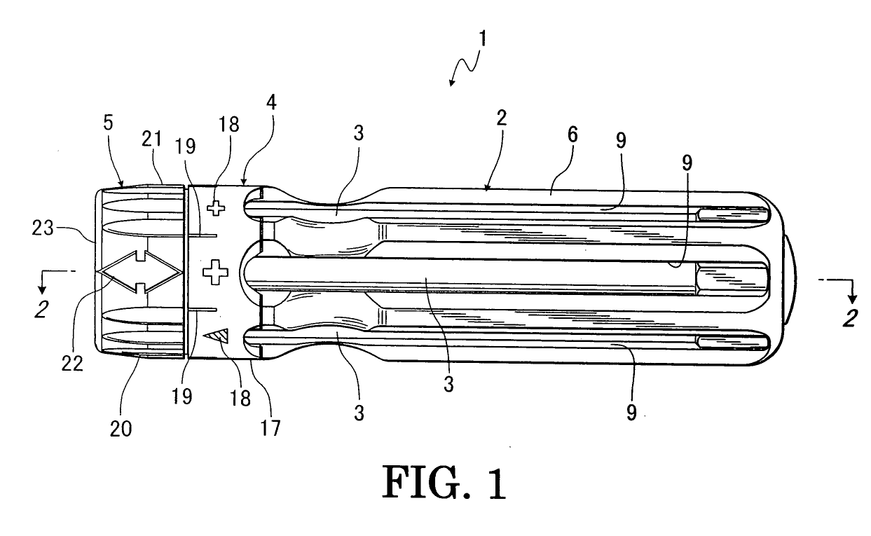

FIG. 1 is a front view of the best mode of carrying out this invention.

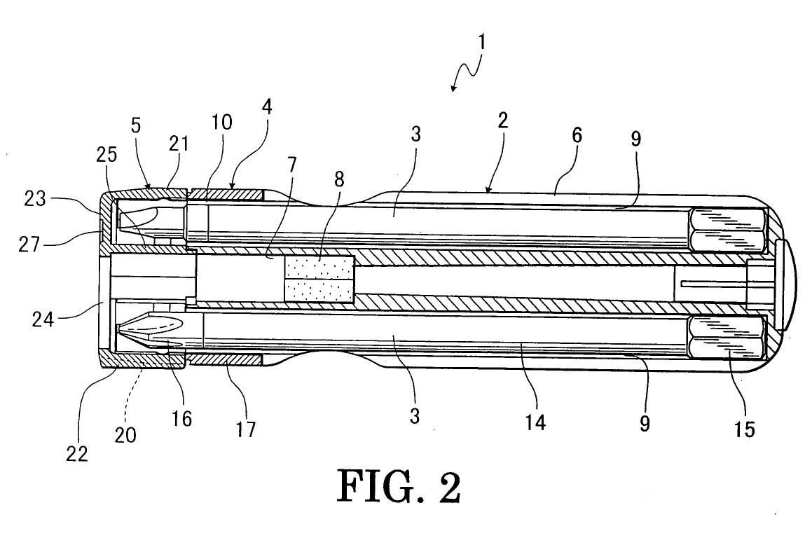

FIG. 2 is a cross section which meets 2-2 line of FIG. 1.

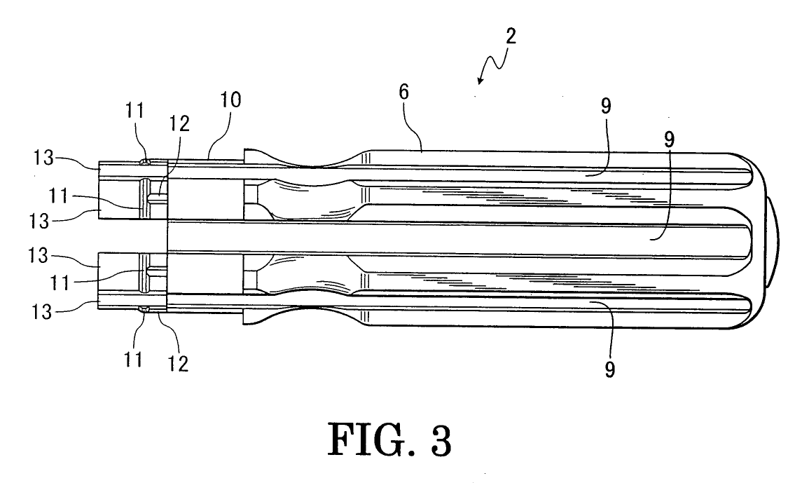

FIG. 3 is a front view of the grip handle of the best mode of carrying out this invention.

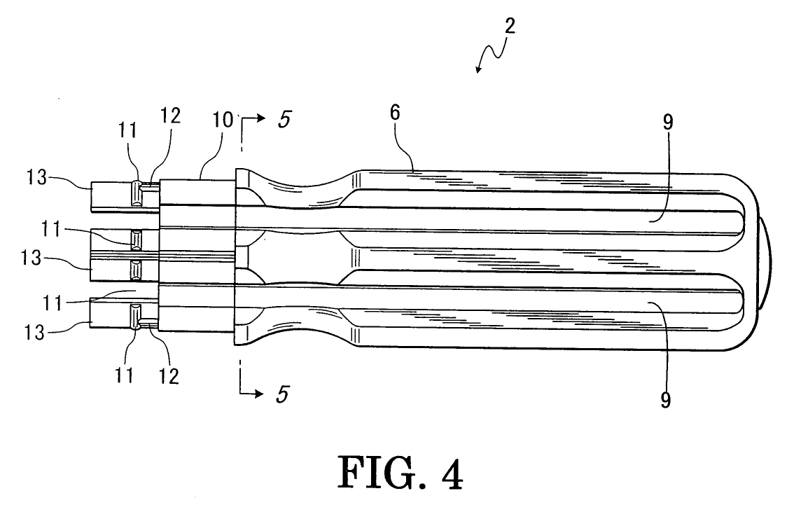

FIG. 4 is a top view of the grip handle of the best mode of carrying out this invention.

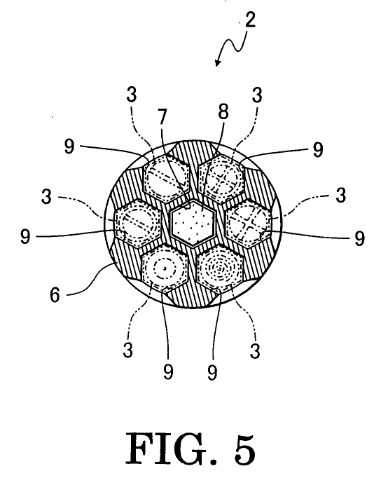

FIG. 5 is a cross section along 5-5 line of FIG. 4.

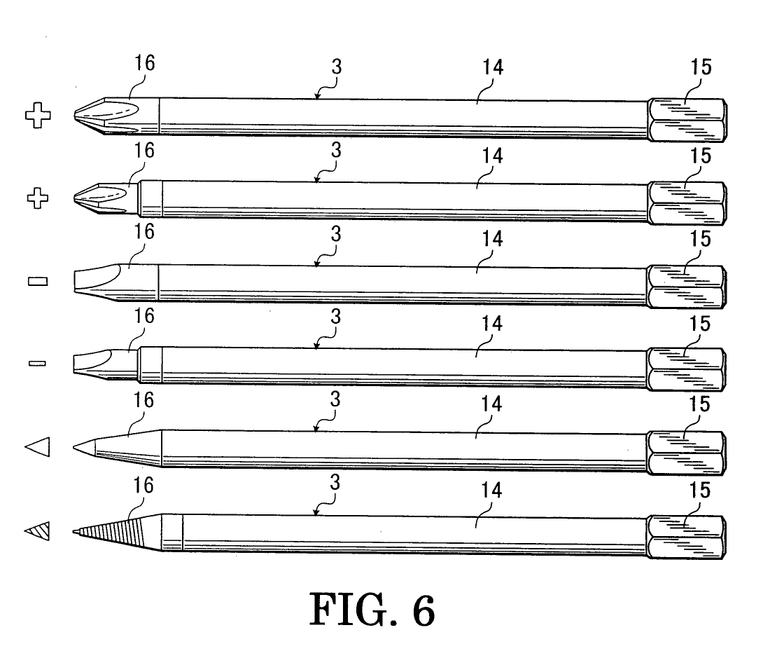

FIG. 6 is an explanatory view of the driver bit of the best mode of carrying out this invention.

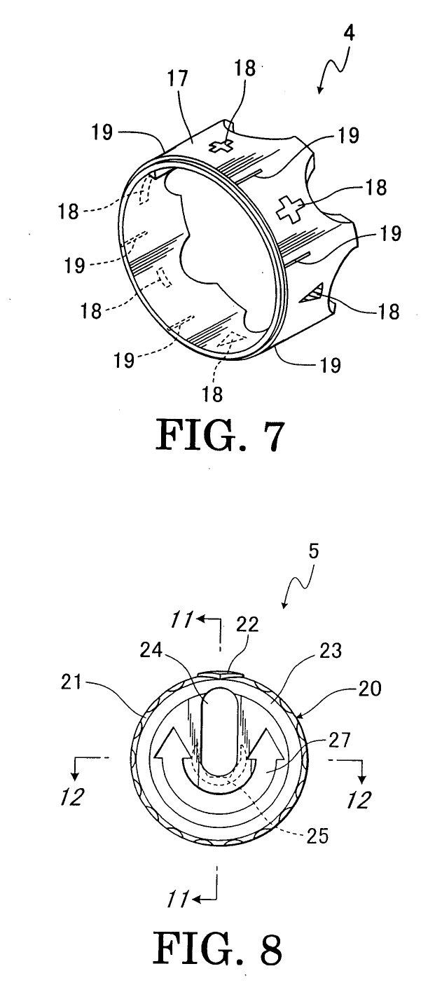

FIG. 7 is an explanatory view of the retaining ring of the best mode of carrying out this invention.

FIG. 8 is a front view of the cap of the best mode of carrying out this invention.

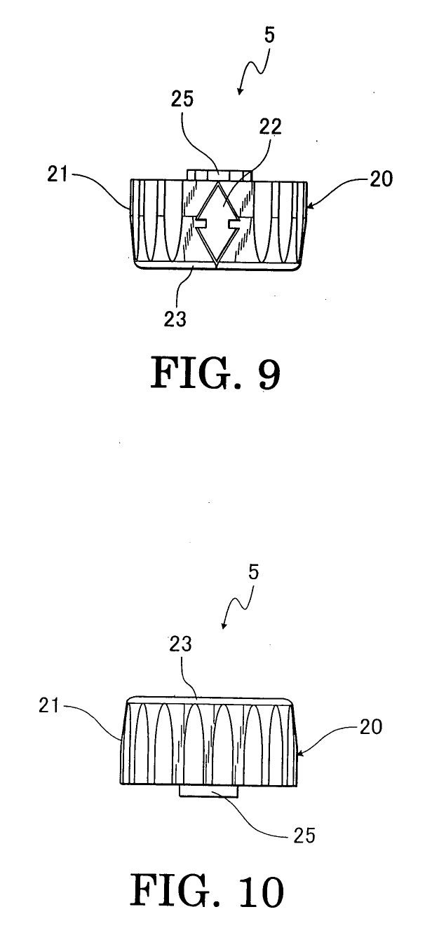

FIG. 9 is a top view of the cap of the best mode of carrying out this invention.

FIG. 10 is a bottom view of the cap of the best mode of carrying out this invention.

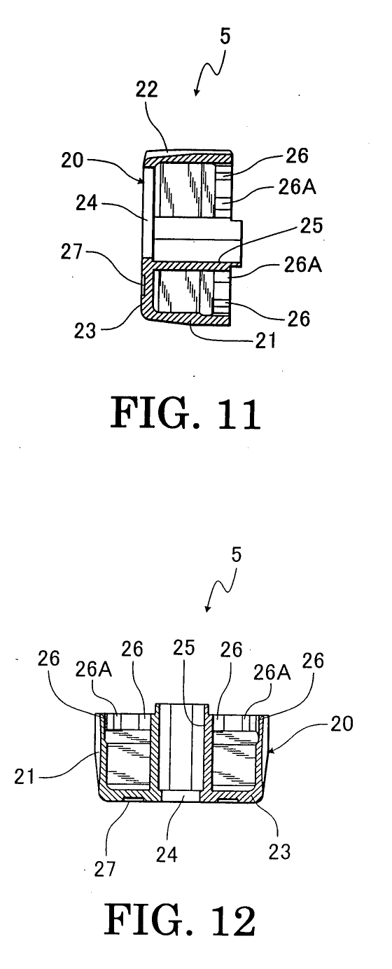

FIG. 11 is a cross section which meets 11-11 line of FIG. 8.

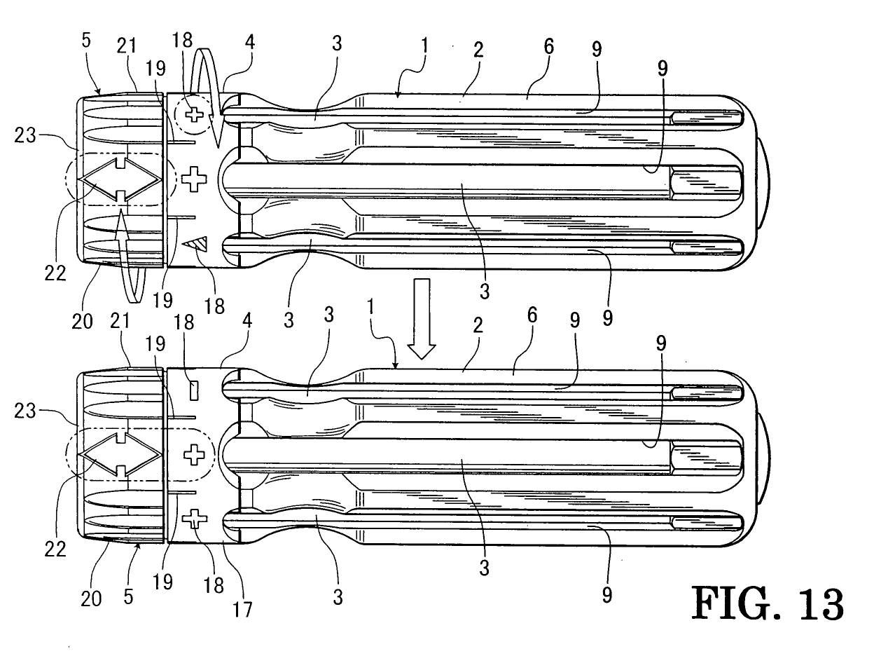

FIG. 12 is a cross section which meets 12-12 line of FIG. 8.

FIG. 13 is an explanatory view of a positioning state in case the best mode of carrying out this invention uses it.

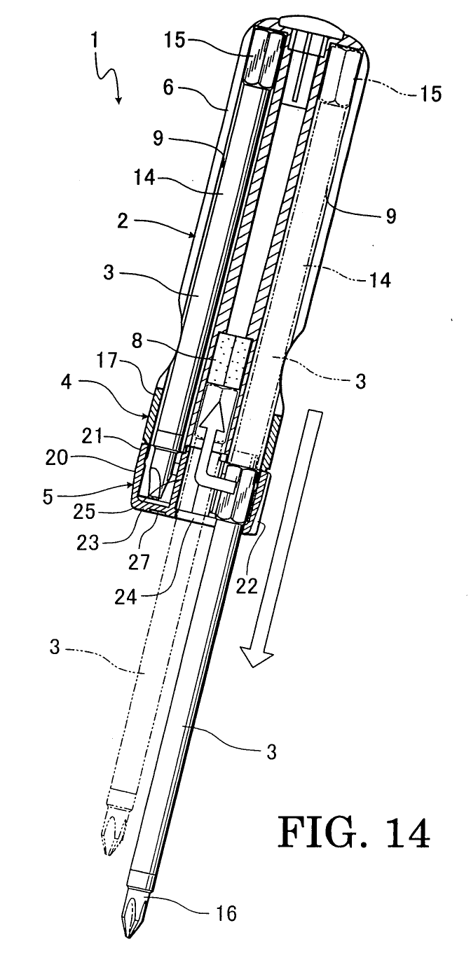

FIG. 14 is an explanatory view in the state of making a driver bit of the best mode of carrying out this invention projecting.

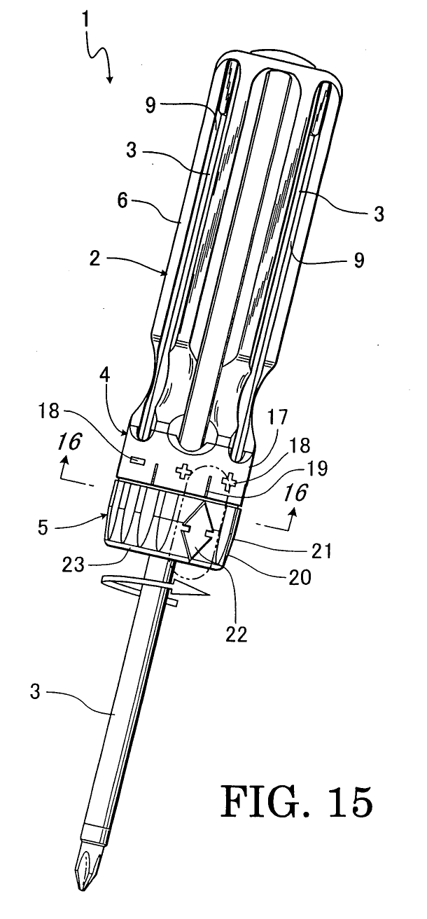

FIG. 15 is an explanatory view of the lock state of the best mode of carrying out this invention.

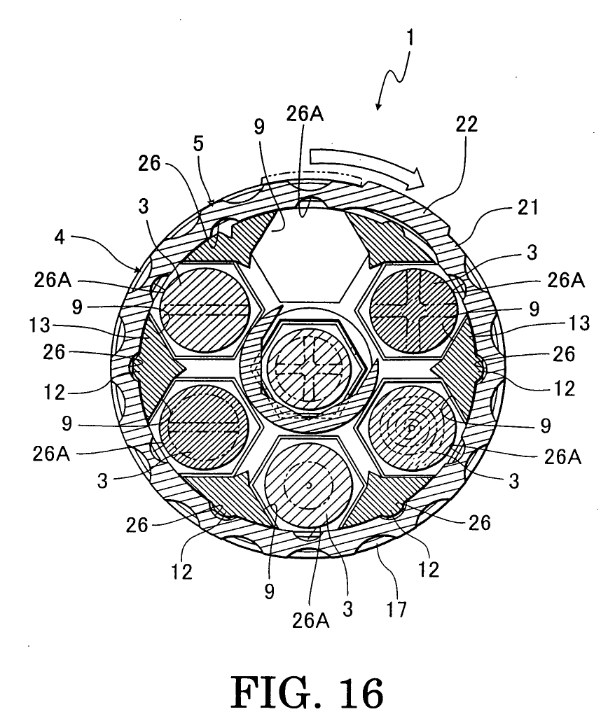

FIG. 16 is an expanded cross section which along 18-18 line of FIG. 15.

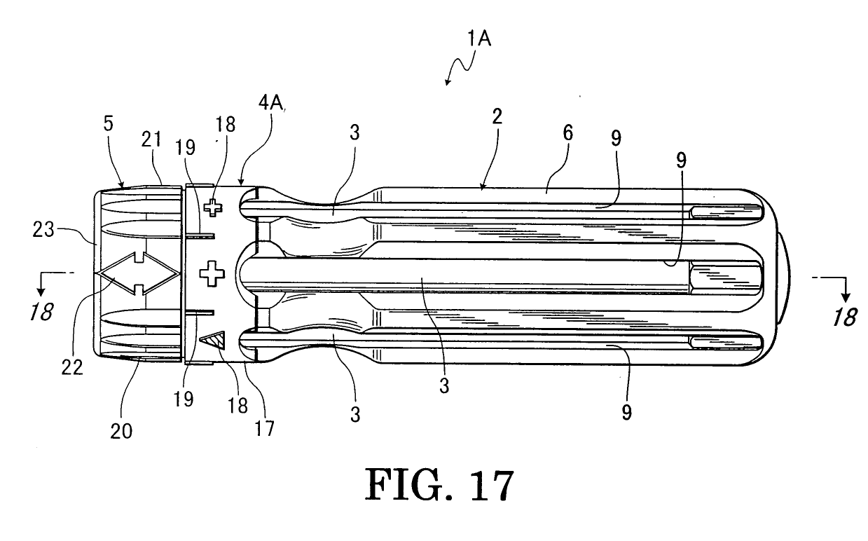

FIG. 17 is a front view of the second mode of carrying out this invention.

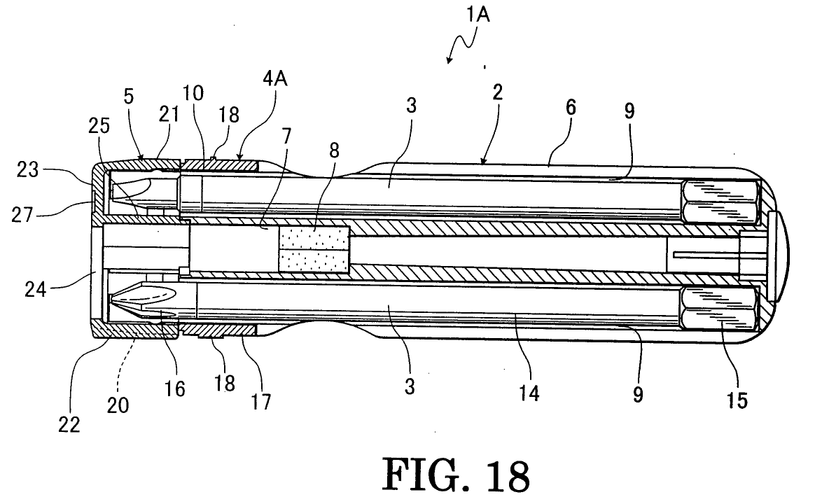

FIG. 18 is a cross section which along 18-18 line of FIG. 17.

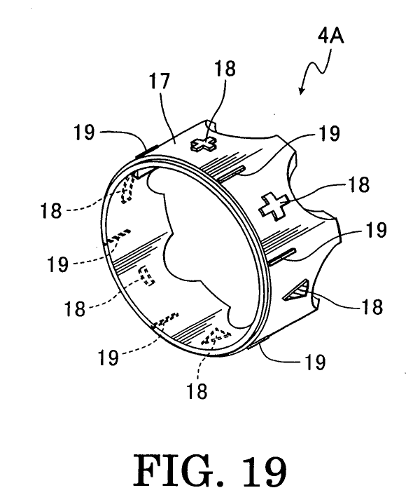

FIG. 19 is an explanatory view of the retaining ring of the second mode of carrying out this invention.

### DESCRIPTION OF THE PREFERRED EMBODIMENT

Following, The best mode of carrying out the invention shown in the drawing explains it in detail. In the best mode of carrying out the invention shown in FIG. 1 or FIG. 16, 1 is the assembly driver of this invention.

The driver bit comprises the six driver bits 3, 3, 3, 3, 3, and 3 was attached in the direction of an axial center possible slide movement with the prescribed interval at the peripheral part of grip handle 2 of this assembly driver and this grip handle 2, a retaining ring 4 attached to the part of the tip part slippage of said grip handle 2, and the cap 5 attached to the tip part of said grip handle 2.

Said hand grip 2 comprises the grip handle body 6 shown in FIG. 3 or FIG. 5, and The driver bit 3 which is used for the central part of the tip part of the grip handle body 6, and the support crevice 7 which formed by the groove of the shape of a hexagon is removable and unrotatable to the rear end part of the driver bit 3, the magnet 8 attached so that the supporter of the driver bit 3 supported by this support crevice 7 could be adsorbed magnetically, and the six driver bit insertion slots 9, 9, 9, 9, 9, and 9 of the outline shape of the shape of a hexagon which can lead the driver bit formed in the direction of the axial center with the prescribed interval at the peripheral part of main part 6 of the grip handle cannot be pulling out and can be slide movement to the said support crevice 7, and the retaining ring supporter 10 formed in the peripheral part of the tip part of the main part 6 of the grip handle, and the engaging projection 11 and locking piece 12 form on the six pieces of the cap engaging 13, 13, 13, 13, 13, and 13, respectively. And the engaging projection 11 and locking piece 12 are formed by the part of the tip peripheral part approach of said grip handle body 6, and are formed in the lateral surface which formed as projection to the method of outside part except said driver bit insertion groove 9, 9, 9, 9, 9, and 9. Said six driver bits 3, 3, 3, 3, 3, and 3 comprise a supporter 15 supported by said support crevice 7 of the shape of a hexagon which projects to the method of outside peripheral part of the rear end part of this axis 14 which shown in FIG. 6, and the tip part of said axis 14, small +, large −, small −, a screw, and awl.

Said retaining ring 4, as shown in FIG. 7, comprises the retaining ring 17 supported by a retaining ring supporter 10 of said grip handle main part 6, and the driver bit Indications 18, 18, 18, 18, 18, and 18 of the driver bit which displays the kind of driver bit formed in the peripheral part of the part in which said six driver bits 3, 3, 3, 3, 3, 3 of this retaining ring main part 17 are located on a print, and the lock indications 19, 19, 19, 19, 19, 19 which mostly formed in the peripheral part by the side of the tip part of retaining ring main part 17 of the central part on a print of indications 18, 18, 18, 18, 18, 18 of this driver bit.

Said cap 5 is shown in FIG. 8 or FIG. 12, comprises the cap body 20 which attach removably and rotatably a piece of the cap engaging 13, 13, 13, 13, 13, and 13 of said grip handle 2, and the positioning indication 22 formed in peripheral wall board 21 of this cap body 20 at the peripheral part, and a guide groove 24 of a shape of a long hole can lead the selected driver bit 3 can project and not pull out, and formed in top plate 23 which corresponds this positioning indication 22 to said support crevice 7, and the base material 25 of the shape of the outline of said supporter 15 really formed so that it could project to an inner side on the inner wall surface of the peripheral wall by the side of the central part of the guide groove 24 of the top plate 23 of said cap body 20, and the six engaging recesses 26, 26, 26, 26, 26, and 26 at the time of the driver bit use are formed in the wall side of the open end of peripheral wall board 21 of said cap body 20 with a prescribed interval, and the engaging recess is engaging with said locking piece 12 and the letter of a click, and The Six engaging recesses 26A, 26A, 26A, 26A, 26A, and 26A at the time of the lock, and the arrow 27 shows the hand of cut.

When using the assembly driver of the above-mentioned composition, the indication 18 of the driver bit used as shown in FIG. 13 made rotate cap 5, and positioning indication 22 is located. After an appropriate time, the tip part of handle 2 as shown in FIG. 14 is located below, the supporter 15 of a rear end part will be larger than guide groove 24, and driver bit 3 to be used will not drop out to the exterior, although the tip part projects from the guide groove 24 of the cap 5.

When using the assembly driver 1 of the above-mentioned composition, the indication 18 of the driver bit used as shown in FIG. 13 made rotate cap 5, and positioning indication 22 is located. After an appropriate time, the tip part of handle 2 as shown in FIG. 14 is located below, the supporter 15 of the rear end part will be larger than guide groove 24, and the driver bit 3 to be used will not drop out to the exterior, although the tip part projects from the guide groove 24 of the cap 5. Next, it will adsorb with magnet 8 by the tip part's having driver bit 3 projected to the method of outside, moving supporter 15 of this driver bit 3 to the central part along guide groove 24, and pushing into support crevice 7.

Although it may be used in this state, as shown in FIG. 15, the cap 5 is rotated for a whiles and the lower end part of base material 25 is located so that supporter 15 of driver bit 3 may not escape from support crevice 7 as by locating positioning indication 22 of cap 5 in lock indication 19 shows to FIG. 16. While in use, it can prevent certainly that supporter 15 of driver bit 3 separates from support crevice 7, and it can be used safely. When the used driver bit 3 is stored, the indication 22 of the cap 5 is located at the indication 18 of the driver bit which is the driver bit by which the driver bit 3 is not stored, and after moving driver bit 3 upwards. When the guide groove 24 is pushed in below along the peripheral part, the driver bit 3 is inserted in the driver bit insertion slot 9. In the place where the driver bit 3 was inserted in the driver bit insertion slot 9, by rotating the cap 5 for a while and the positioning of the indication 22 is located in lock the indication 19, the guide groove 24 of the cap 5 will be in the state where it is open for free passage to neither of the driver bit insertion slots 9, 9, 9, 9, 9, and 9 so that It prevents certainly the driver bits 3, 3, 3, 3, 3, and 3 projecting to the method of outside the handle 2 at the time of non-use.

### Different Preferred Embodiments of the Invention

Next, the different form for carrying out this invention shown in FIG. 17 or FIG. 19 is explained. The explanation gives the same numerals to The best mode and the identical configuration portion for carrying out said this invention, and the overlaps is omitted in explanation of the different form for carrying out this invention.

The main different point from The best mode for carrying out said this invention in the second mode for carrying out this invention shown in FIG. 17 or FIG. 19 is the point of using the retaining ring 4A displayed by the indications 18, 18, 18, 18, 18, and 18 of the driver bit and the projection part of the lock indications 19, 19, 19, 19, 19, and 19, and the same operation effect as the best mode for the assembly driver 1A constituted in this way to carry out said this invention is obtained.

### Advances of the Invention

Clear from the above description, the effect that it next enumerates is acquired in this Invention.

(1) a guide groove of a long hole shape make the part excluding the root part of any one driver bit which was formed in top plate of the cap attached several pieces of the cap engaging rotatably and removably project to the method of outside and lead the driver bit to the support crevice. The base material of the outline shape of the supporter of the driver bit mostly and it was really formed so that it might project to the inner side in the inside wall of the circumference wall by the side of the central part of the guide groove of the top plate of the cap. The locking peace formed in the inner wall of the open end of the cap so that it can stop the rotation part which can prevent that plurality driver bits enter to the guide groove of this cap. Since the driver is constituted by them, the guide groove and base material which are attached to the tip part of the grip handle, and one part of the cap in which the plurality of engaging recesses were formed. The set in the state where the selected driver bit can be used, prevention of the projection of the non-use driver bit in condition of use, and the driver bit of the condition of use can be stored by the rotation operation of one cap. Therefore, it can prevent certainly that operation gets confused like before, and it is easy.

(2) With the above (1), structure is easy and reduction of cost can be aimed at.

(3) With the above (1), it can be made infallible, without being able to perform prevention of the projection of the selection of the driver bit used only by rotating the cap, and the driver bit at the time of non-use, and nobody gets confused.

(4) The effect as said (1)˜(3) also with same claim 2 is acquired, and can be aimed at prevention of movement of the driver bit by rotation of the cap when the implement is in use.

(5) The effect as said (1)˜(3) also with same claim 3 is acquired, and can be aimed at prevention of movement of the driver bit by rotation of the cap when the implement is in use.

What is claimed is:

1. An assembly driver comprising:
a support crevice, supported rotatably and removably is formed in the rear end part of the driver bit used for the tip central part at the grip handle;
a plurality of driver bit insertion slots, can lead the driver bit which formed in the direction of an axial center with the prescribed interval at the peripheral part of this grip handle to the support crevice and slide movement of the driver bit can be carried out, and the drover bit cannot be pulled out;
a plurality of driver bits, have said support crevice and a supporter supported rotatably in the rear end part inserted in the plurality of these driver bit insertion slots respectively;
a retaining ring, in which the driver bit indication which displays the kind of the driver bit covered the peripheral part of tip part slippage of said grip handle, and was inserted in said plurality of the driver bit insertions inside slot was formed, and the tip of said grip handle;
a piece of a cap engaging, a part from the tip perimeter of said grip handle, and it is formed so that it may project to the method of outside part except said driver bit insertion slot;
a cap, can attach rotatably the plurality of these pieces of the cap engaging;
a guide groove of a long hole shape, make the part excluding the root part of any one driver bit which was formed in top plate of the cap attached several pieces of the cap engaging rotatably and removably project to the method of outside and lead the driver bit to the support crevice;
a base material, carrying out outline shape of the supporter of said driver bit mostly, and it is really formed so that it may project to an inner side on an inner wall surface of a peripheral wall by the side of the central part of said guide groove of the top plate of said cap;
a locking piece, formed in an inner wall surface of an open end of said cap, and formed in said the plurality pieces of the cap engaging so that it can stop to the rotation part which can prevent that said plurality of the driver bits enter to the guide groove of this cap; and
a plurality of engaging recesses, stopped by the locking piece.

2. This assembly driver according to clam 1, wherein the support crevice of the grip handle is a hexagonal groove, and several root part of the driver bits which project to the method of outside axial part is formed the hexagonal, said root part makes the driver bit support the support crevice. Several root part of the driver bits make the driver bit support the support crevices and if it is made rotate the part for none of the driver bits to enter guide groove of the cap. The part projecting to the method of outside the root part engages with the lower end part of the base material, and can be prevented from pulling out the support crevice.

3. This assembly driver according to claims 1 or 2, wherein the locative calls which prevent movement of the driver bit are formed an interval of the driver bit indications of the retaining ring.
